(19) United States
(12) Patent Application Publication
(10) Pub. No.: US 2020/0389633 A1
(43) Pub. Date: Dec. 10, 2020

(54) TWO-PIECE LCD PROJECTOR BASED ON PBS LIGHT SPLITTING-CONVERGING MANNER

(71) Applicant: NAHHUA INTELLIGENT PRECISION MACHINE (SHENZHEN) CO., LTD., Shenzhen (CN)

(72) Inventor: Hanwen GUO, CHENGDU (CN)

(73) Assignee: NAHHUA INTELLIGENT PRECISION MACHINE (SHENZHEN) CO., LTD.

(21) Appl. No.: 16/689,291

(22) Filed: Nov. 20, 2019

(30) Foreign Application Priority Data
Jun. 6, 2019 (CN) 201910494549.3

(51) Int. Cl. H04N 9/31; G02F 1/1335; G02B 27/26; G03B 21/14

(52) U.S. Cl. CPC H04N 9/3197; G02F 1/13362; G02F 2001/13355; G03B 21/14; G02B 27/26

(57) ABSTRACT

The disclosure provides a two-piece LCD projector based on a PBS (polarization beam splitter) light splitting-converging manner, including a first PBS device, a second PBS device, a first LCD light valve module and a second LCD light valve module, wherein a light emitted by an LED light source is divided into two paths of polarized lights namely P light and S light by the first PBS device after passing through a spotlighting device, one path is the S light which is irradiated to the first LCD light valve module, the other path is the P light which irradiated to the second LCD light valve module, the lights pass through two LCD light valve modules to be converged by the second PBS device, and the converged light passes through a field lens and a projection lens and finally reaches a screen, thereby achieving a projection function.

### CROSS-REFERENCE TO RELATED APPLICATIONS

This application claims priority to Chinese Patent Application No. 201910494549.3 with a filing date of Jun. 6, 2019. The content of the aforementioned applications, including any intervening amendments thereto, are incorporated herein by reference.

### TECHNICAL FIELD

The disclosure relates to a two-piece LCD projector.

### BACKGROUND OF THE PRESENT INVENTION

For a long time, people habitually classify projectors based on, characteristics of a light valve, one of the most core devices of the projector in general, such as a DLP (digital light processing) projector, an LCD (liquid crystal display) projector, an LCOS (liquid crystal on silicon) projector, which are common at present.

The common LCD projector all has two characteristics that the light valve adopts an LCD technology (for distinguishing DLP) and is of a transmission type (for distinguishing LCOS). The LCD projector generally has two principles and structure forms of a signal LCD projector and a 3LCD projector, the general single LCD projector uses a full-color LCD light valve to reproduce space color images under, the illumination of a white light source or equivalent white light source. The general 3LCD projector uses three single-color (black and white) LCD light valves, that is, there is no CF (color filter, color filter film, color film, etc.) device used by the light valve of the single LCD projector on the LCD light valve, and red, green and blue three primary colors are respectively used for illuminating three paths of LCD light valves, each path of LCD light valve displays a pure primary color field image of an input video signal, and finally overlaps the images generated by the three light valves, so as to generate a spatial color image like the single LCD projector using full-color LCD light valve.

The single LCD projector is low in cost and simple in fabrication, has brightness ranging from more than ten lumens to three or four hundred lumens, and certain practicability and competitiveness; the 3 LCD projector is rich in color, good in picture quality and high in brightness, but complicated in fabrication and high in access threshold, so the 3 LCD projector is high in product cost, has brightness ranging from 800 to 8000 lumens, and is the main product of the traditional commercial and educational projector market. Throughout the projection product market in recent years, there are mainly products having principle forms of 3LCD projectors, single LCD projectors and DLP projectors.

The biggest disadvantage of the single LCD projector is that the “energy conversion efficiency” η is too low. Generally, the definition of η is: η=[output brightness (Lm)/input electric power (w)/100 (Lm/w)*100%], in which the LED light efficiency is calculated according to the typical value of 100 lumens/watt of a high-power LED module, in such a way, η is usually only 2%-3.5%. However, for 3LCD and DLP projectors using light sources such as UHP bulbs, LED and laser, their η can easily reach 10% or even more than 25%. There are many reasons why the η of the single LCD projector is low, among which the loss caused by the polarizer is more than 60%, so how to reduce the loss is a long-term research and development subject in the industry.

For the LCD projector, the single LCD or 3LCD technology, because of the slow response speed of the light valve, has a great disadvantage that its single machine has no excellent 3D (3 Dimension) display function same as the DLP projector, such as shutter 3D (active shutter) display function. Specifically, the single LCD projector does not have the function of shutter 3D at all; however, for the latest 3LCD projector, abnormal phenomena such as image tailing must be overcome by turning off 3D glasses when the shutter 3D function is opened, that is, when the display is abnormal, the wearing 3D glasses are closed so that the human eyes can not see the images, so the brightness obtained by the human eyes is, directly lost by 6-8 times in general, and people can strenuously watch the images, so the single LCD projector can only be used as a poor experience of color difference 3D (anaglyphic 3D) and other ways for 3D display, and such 3D often has not practicability.

Mother excellent 3D display is polarization 3D, which requires two projectors to be stacked together to work when a video signal source (two paths of signals must be output) is configured. The pictures of the two projectors should be perfectly overlapped, and various light and color indexes should be consistent as much as possible.

When polarization 3D display is performed by stacking two DLP projectors, one polarizer is set at the exit of the lens. The axe of the two polarizers are orthogonal, and the total brightness loss is about 60%. However, because the two projectors simultaneously work, relative to the original single machine, the total brightness after loss is only slightly lower than that of the original single, and there is no flicker of the shutter 3D, so it can provide users with excellent 3D experience, and commercial cinemas tend to preferably consider polarization 3D.

When two 3LCD projectors are stacked for polarized 3D display, one polarizer should be set in front of the lens respectively, and the vibration axe of the two polarizers are orthogonal. If the color combiner such, as X-cube (X prism) inside the single machine is of an SPS (RGB tricolor is S light, P light and S light) manner, serious brightness loss and color deviation will occur; if the color combiner such as X-cube inside the single machine is of an SSS (RGB tricolor is S light, S light and S light) manner, the brightness loss of one machine is extremely great, and the brightness difference between left and right eyes is extremely great, which can affect 3D experience. Therefore, even if the two machines are adopted for polarization 3D display, 3LCD is not suitable without special fabrication.

### SUMMARY OF PRESENT INVENTION

The technical problem to be solved by the disclosure is to provide a two-piece LCD projector and an projection method based on a PBS (polarization beam splitter) light splitting-converging manner aiming at the disadvantages that the energy conversion efficiency of the single LCD projector is low, the polarizing and filtering loss of natural light is large, and the single machine has no shutter and polarization 3D function; for the existing 3LCD projector, the shutter 3D function of the single machine is basically not practical, and the polarization 3D function of the two machines has too much color deflection or one-path brightness reduction, thereby achieving the increased cost of energy conversion efficiency and realizing the excellent 3D display function. The two-piece LCD projector provided by the disclosure is simple in structure and low in cost.

The technical solution to solve the technical problem by the disclosure is to provide a two-piece LCD projector based on a PBS light splitting-converging manner, comprising: an LED light source, a spotlighting device, a holophote, a first PBS device, a holophote, a focusing lens, a first LCD light valve module, a holophote, a focusing lens, a second LCD light valve module, a second PBS device, a field lens and a projection lens, wherein, a light emitted by the LED light source is irradiated to the first PBS device after passing through the spotlighting device and the holophote, an incident light is divided into two paths of polarized light namely P light and S light by the first. PBS device, one path is the S light which is irradiated to the first LCD light valve module, and the light rotates by 90° to change from S light to P light and emitted to the second PBS device when passing through the first LCD light valve module; the other path of polarized light namely P light separated by the first PBS device is irradiated to the second LCD light valve module, the light rotates by 90° to change from P light to S light and emitted to the second PBS device when passing through the second LCD light valve module; the second PBS device converges the P light from the first LCD light valve module and the S light from the second LCD light valve module, the converged light passes through the field lens and the projection lens and finally reaches the screen.

In some embodiments, the first PBS device and the second PBS device select a reflective polarizer whose one face is adhesive and has 45° incident light to be pasted to white or green plate glass so as to prepare a PBS module, thereby realizing optical functions of PBS.

In some embodiments, the first PBS device selects a PBS prism; the second PBS device selects the PBS prism.

In some embodiments, the first PBS device selects the PBS module or PBS prism made by the reflective polarizer having 45° incident light; the second PBS device selects the PBS module or PBS prism made by the reflective polarizer having 45° incident light.

In some embodiments, the first LCD light valve module and the second light valve module are full-color transmission type LCD light valves having the same, resolution and the same window size.

In some embodiments, the transmission axis of the polarizer at the incidence side of the first LCD light valve module is necessarily consistent to the reflection axis of the first PBS device; the transmission axis of the polarizer at the incidence side of the second LCD light valve module is necessarily consistent to the transmission axis of the second PBS device.

In some embodiments, the first PBS device, the first LCD light valve module, the second LCD light valve module and the second PBS device must meet the characteristic requirements on polarization phases of the material on optical paths, and requirements of optical paths are met by inserting a phase difference board under the conditions that a raw material or installation arrangement cannot meet the characteristic requirements of various polarization phases of the optical paths.

The disclosure has the beneficial effects that by ingeniously adding a second LCD light valve and two PBS devices on the basis of the single LCD projector, the polarized light lost in the optical path of the single LCD projector can be sufficiently utilized, thereby achieving higher energy conversion efficiency, and simultaneously providing excellent and complete 3D display functions.

### DESCRIPTION OF THE DRAWINGS

The disclosure will be further described in combination with drawings and embodiments. In the drawings:

FIG. 1 illustrates, a principle structure of a two-piece LCD projector based on a PBS light splitting-converging manner according to the disclosure.

FIG. 2 illustrates another structure of a two-piece LCD projector based on a PBS light splitting-converging manner according to the disclosure.

### DETAILED DESCRIPTION OF PREFERRED EMBODIMENTS

Preferred embodiments will be described in detail with reference to drawings.

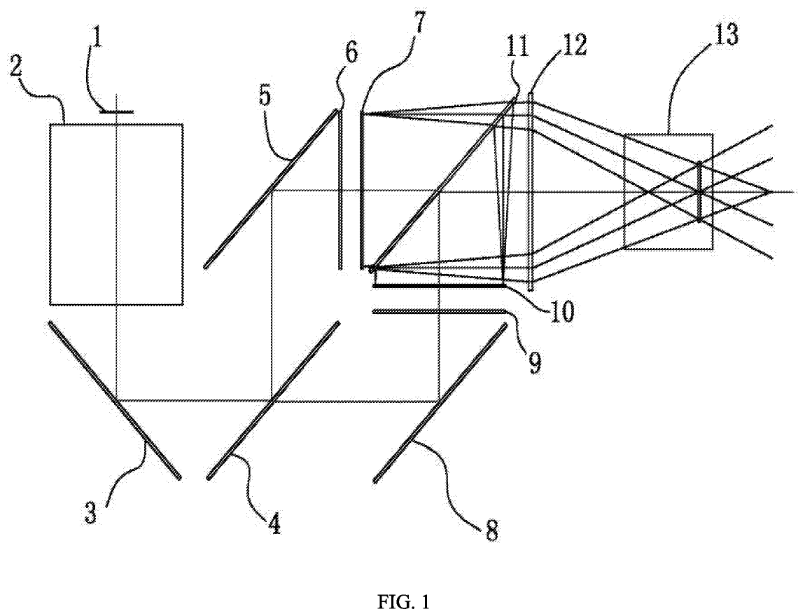

Referring to FIG. 1, FIG. 1 illustrates a principle structure of a two-piece LCD projector based on a PBS light splitting-converging manner according to the disclosure. The two-piece LCD projector shown in FIG. 1 includes an LED light source 1, a spotlighting device 2, a holophote 3, a first PBS device 4, a holophote 5, a focusing lens 6, a first LCD light valve module 7, a holophote 8, a focusing lens 9, a second LCD light valve module 10, a second PBS device 11, a field lens 12 and a projection lens 13.

The basic work principle of the two-piece LCD projector of the disclosure is that the light, emitted by the LED light source 1 is irradiated to the first PBS device 4 after passing through the spotlighting device 2 and the holophote 3, the first PBS device 4 divides an incident light into two paths of polarized lights namely P light and S light, one path is the S light which is irradiated to the first LCD light valve module 7 after passing through the holophote 5 and the focusing lens 6, and the light passing through the first LCD light valve module 7 is the P light and emitted to the second PBS device 11 because the first LCD light valve module 7 has rotation characteristic and incident and transmission axe, namely phases, coming into and emitting out of the polarizer, are orthogonal; the other path of polarized light, namely P light, separated by the first PBS device 4 is irradiated to the second LCD light valve module 10 after passing through the holophote 8 and the focusing lens 9, and the light passing through the second LCD light valve module 10 is the S light and emitted to the second PBS device 11 because the second LCD light valve module 10 has rotation characteristic and phases coming into and emitting out of the polarizer are orthogonal; the second PBS device 11 converges the P light from the first LCD light valve module 7 and the S light from the second LCD light valve module 10, the converged light passes through the field lends 12 and the projection lens 13 and finally reaches the screen, thereby achieving the function of projection.

The LED light source 1 selects white light LED or three primary color RGB type LED, and the luminous area, is comprehensively determined by the cost expectation of the projector, the level of the output brightness, the Etendue value of the LCD light valve, and the Fno value (aperture number) of the lens and other factors.

One function of the spotlighting device 2 is to converge the light emitted by the LED light source 1 so that, it can be irradiated to the first PBS device 4 according to the requirements on the design solid angle of the light beam; the other function is to meet the uniform lighting conditions for the design of the first LCD light valve module 7 and the second LCD light valve module 10; considering the efficiency and cost of splitting and converging the lights of the PBS devices of the two-piece LCD projector of the disclosure, the solid angle of the light irradiated to the PBS device is preferably designed within 7° at one side.

The first. PBS device 4 is fabricated into the PBS module using 4 reflecting polarizer with 45° incident light or the PBS prism. The characteristics of the transmission axis and reflection axis of the first PBS device 4 determine the transmission, axis phase of the subsequent phase difference plate, the transmission axis phase of the polarizer, at the incident side of the LCD light valve module the transmission axis and reflection axis phases of the second PBS device 11.

Me, focusing lenses 6 and 9 provide collimating lighting for the LCD light valve on a Kohler lighting device system, and focus an LED light source image or a sub light source image separated from a light integrating device of an illuminating device on the LCD light valve window on a critical illuminating device system; when the size of the LCD light valve is small (such as ≤3 inch), the focus lenses 6 and 9 can select glass lenses to improve performance; when the size of the LCD light valve is large (e.g. 4-7 inches), the focus lenses 6 and 9 can select plastic Fresnel lenses to reduce cost.

The first and second LCD light valve modules 7 and 10 select full-color transmission type LCD screens having the same size and pixel number. In FIG. 1, the transmission axe of the polarizers at the incident side of the two LCD light valves are orthogonal, that is, the characteristics of the polarizers of the two LCD light valve modules 7 and 10 are different; if the characteristics of the transmission axe of the polarizers at the incident side of the two LCD light valve modules are the same, it is required to respectively set one ½ wave plate (generating 90° phase difference) at the incident side and emergent side of the second LCD light valve module 10, so that the working conditions of the second PBS device meet design requirements.

If it is desirable to output a higher brightness, the LCD light valve module is inevitably irradiated by a stronger light. At this moment, it is usually desirable to take the polarizer at the incident side of the LCD light valve module from the LCD glass to be pasted to a separate glass plate, and effective measures, such as air cooling, are used to perform heat dissipation on the polarizer and LCD light valve.

In the shutter 3D display, an image of an eye is displayed through two LCD light valve modules 7 and 10 respectively. The glasses do not need the shutter 3D glasses similar to the DLP projector, but the polarized 3D glasses matching with the polarization axis of the second PBS device 11 of the disclosure is used, which can better realize the shutter 3D function. Compared with the shutter 3D display of the DLP projector, the image of the disclosure has no flicker sense and no significantly reduced brightness, thereby achieving the excellent effect of the polarized 3D, when in the polarized 3D display, there is no need to stack two projectors or set a polarizer in front of the projection lens for filtering. The two LCD light valve modules 7 and 10 each independently and completely display an input image. It is only needed that the polarization characteristics of the polarization 3D glasses are matched with the second PBS device 11, and thus the excellent polarization 3D function can be realized. Compared with the stacking of double machines, the disclosure has no disadvantages of color deviation, uneven left and right eyes, brightness loss and the like.

Together with the field lens 12 and the lens 13, the images displayed on the first and second LCD light valve modules 7 and 10 are projected to the screen.

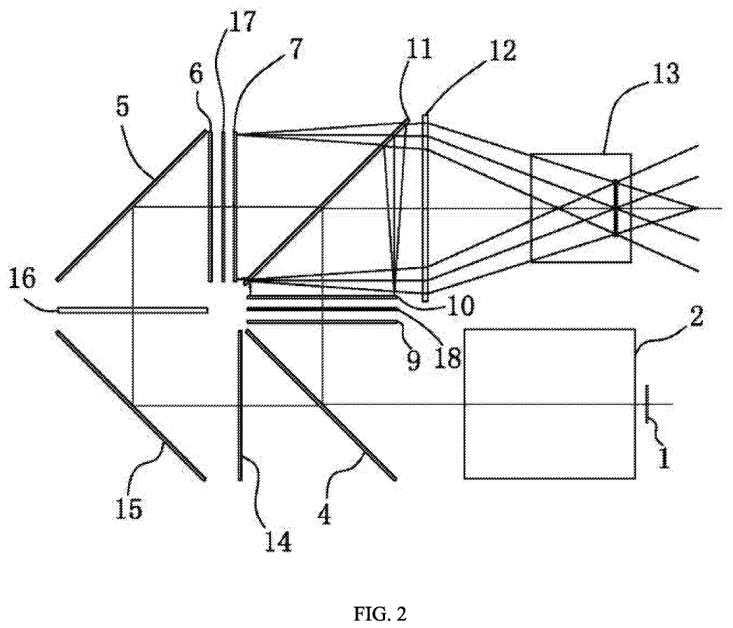

Referring to FIG. 2, FIG. 2 illustrates another structure of the two-piece LCD projector based on PBS on-off light according to the disclosure. The structure shown in FIG. 2 can be adopted in the case that the appearance shape, optical path arrangement and phase difference plate are different from those shown in FIG. 1. The two-piece LCD projector shown in FIG. 2 includes: an LED light source 1, spotlighting device 2, a first PBS device 4, a holophote 5, a focusing lens 6, a first LCD light valve module 7, a focusing lens 9, a second LCD light valve module 11, a second PBS device 11, a field lens 12, a projection lens 13, a relay lens 14, a holophote 15, a relay lens 16 and a phase difference plates 17 and 18.

Specifically, the phase difference plates 17 and 18 select 90° phase difference plates, and the function of the 90° phase difference plate is realized by sticking a 112 wave plate film with one adhered side on the white or green plate glass. The phase difference plates 17 and 18 are not limited to be certainly placed on the incident side of the LCD light valve, and also be placed on the emergent side of the LCD light valve. The main restriction conditions are that the first PBS device 4, the first LCD light valve module 7, the second LCD light valve module 10 and the second PBS device 11 must meet thee requirements on the characteristics of the material polarization phase on the optical path. In a case that the existing raw materials or installation layout cannot meet the requirements of various polarization phases on the optical path, the optical path requirements are met by inserting the phase difference plates 17 and 18.

The characteristics of the first LCD light valve module 7 selected in FIG. 2 is equivalent to those of the first LCD light valve module 7 in FIG. 1, and the characteristics of the second LCD light valve module 10 selected in FIG. 2 is equivalent to those of the second LCD light valve module 10 in FIG. 1, so 90° phase difference plates 17 and 18 need to be added.

The relay lens 14, the holophote 15 and the relay lens 16 shown in FIG. 2 are optical materials set for ensuring that the p-light separated from the first PBS device 4 can efficiently and smoothly reach the focus lens 6.

It should be understood that the above embodiments are only for explaining the technical, solution of the disclosure, but not to limit thereto. For those skilled in the art, the technical solution described in the above embodiments can be modified, or some of the technical features can be replaced equivalently; and these modifications and replacements shall belong to the scope of protection of the appended claims of the disclosure.

1. A two-piece LCD projector based on a PBS (polarization beam splitter) light splitting-converging manner, comprising:
an LED (light-emitting diode) light source,
a spotlighting device, a holophote,
a first PBS device,
a first holophote,
a first focusing lens,
a first LCD light valve module,
a second holophote,
a second focusing lens,
a second LCD light valve module,
a second PBS device,
a field lens and
a projection lens,
wherein a light emitted by the LED light source is irradiated to the first PBS device after passing through the spotlighting device and the first holophote; the light incident on the first PBS device is divided into a first P polarized light and a first S polarized light by the first PBS device; wherein the light reflected by the first PBS device becomes the first S polarized light; the light transmitted by the first PBS device become the first P polarized light;
the first S polarized light is incident on the first LCD light valve module after reflected by the first holophote and passing through the first focusing lens; wherein the first focusing lens is located between the first holophote and the first LCD light valve module, configured for focusing the first S polarized light, which is reflected by the first holophote, on the first LCD light valve module;
the first P polarized light is incident on the second LCD light valve module after reflected by the second holophote and passing through the second focusing lens; wherein the second focusing lens is located between the second holophote and the second LCD light valve module, configured for focusing the first P polarized light, which is reflected by the second holophote, on the second LCD light valve;
the first S polarized light, which is incident on the first LCD light valve module, passes through the first LCD light valve module and becomes a second P polarized light emitting on the second PBS device;
the first P polarized light, which is incident on the second LCD light valve module, passes through the second LCD valve module and becomes a second S polarized light emitting on the second PBS device;
the second P polarized light and the second S polarized light are converged by the second PBS device and become a converged light; the converged light transmits through the filed lens, the projection lens, and reaches the screen, thereby achieving the function of projection; and
the first PBS device and the second PBS device are both reflective polarizer; the reflective polarizer comprises an adhesive face having 45° incident light so that the reflective polarizer is capable of being pasted to white or green plate glass.

2-3. (canceled)

4. The two-piece LCD projector according to claim 1, wherein the first PBS device is the PBS module or PBS prism made by the reflective polarizer having 45° incident light; the second PBS device is the PBS module or PBS prism made by the reflective polarizer having 45° incident light.

5. The two-piece LCD projector according to claim 1, wherein the first LCD light valve module and the second LCD light valve module are full-color transmission type LCD light valves having the same resolution and window size.

6. The two-piece LCD projector according to claim 1, wherein a first transmission axis of the first polarizer at a first incidence side of the first LCD light valve module is consistent to a first reflection axis of the first PBS device;
a second transmission axis of the second polarizer at a second incidence side of the second LCD light valve module is consistent to a PBS transmission axis of the second PBS device.

7. The two-piece LCD projector according to claim 1, wherein the first PBS device, the first LCD light valve module, the second LCD light valve module and the second PBS device meet the characteristic requirements on polarization phases of the material on optical paths, and requirements of optical paths are met by inserting a phase difference board under the conditions that a raw material or installation arrangement cannot meet the characteristic requirements of various polarization phases of the optical paths.
